(19) United States
(12) Patent Application Publication
(10) Pub. No.: US 2016/0229386 A1
(43) Pub. Date: Aug. 11, 2016

(54) TRANSMISSION ASSEMBLY WITH ELECTRICAL NOISE REDUCTION AND METHOD OF MAKING AND USING THE SAME

(71) Applicant: GM Global Technology Operations LLC, Detroit, MI (US)

(72) Inventors: William T. Ivan, Shelby Township, MI (US); Rajeev Vyas, Rochester Hills, MI (US); Dustin Willim, Brighton, MI (US); Roger B. Hackney, Fenton, MI (US)

(21) Appl. No.: 14/615,809

(22) Filed: Feb. 6, 2015

(51) Int. Cl. H02K 11/02; C25D 13/12; B60K 1/00

(52) U.S. Cl. CPC B60W 20/10

(57) ABSTRACT

A number of variations may include a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft.

TECHNICAL FIELD

The field to which the disclosure generally relates to includes electrical noise reduction components in systems.

### BACKGROUND

Electrical noise reduction components may be used in a variety of applications including, but not limited to, vehicle transmissions and components thereof.

### SUMMARY OF ILLUSTRATIVE VARIATIONS

A number of variations may include a product having a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft.

A number of variations may include a method including providing a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft; and operating the transmission assembly such that the noise reduction component reduces electromagnetic interference from the transmission assembly to the driveshaft.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a product including a transmission assembly with electrical noise reduction according to a number of variations.

FIG. 2 illustrates a product including a transmission assembly with electrical noise reduction according to a number of variations.

FIG. 3 illustrates a product including a transmission assembly with electrical noise reduction according to a number of variations.

FIG. 4A illustrates a product including a transmission assembly with electrical noise reduction according to a number of variations

FIG. 4B illustrates a graph of noise of product including a transmission assembly with electrical noise reduction according to a number of variations

FIG. 5 illustrates a method according to a number of variations.

### DETAILED DESCRIPTION OF ILLUSTRATIVE VARIATIONS

The following description of the variations is merely illustrative in nature and is in no way intended to limit the invention, its application, or uses.

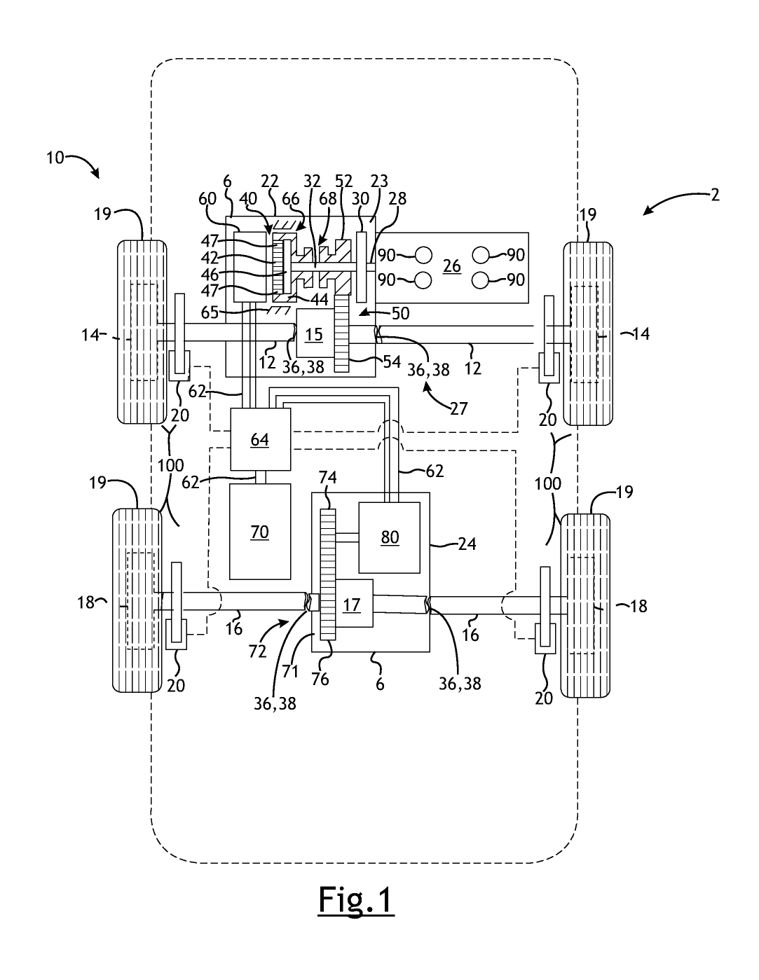

FIG. 1 shows a number of variations. In a number of variations, a product 10 is shown. In a number of variations, the product 10 may include a vehicle such as, but not limited to, a motor vehicle, watercraft, spacecraft, aircraft, or may be another type. In a number of variations, the vehicle 10 may include an electric vehicle, a hybrid electric vehicle (HEV) that is gasoline and electric powered, a plug-in hybrid electric vehicle (PHEV), a battery electric vehicle (BEV), a plug-in electric vehicle (PEV) or may be another type. In a number of variations, the vehicle may include a first driveshaft 12 connected to a first pair of wheels 14 and a second driveshaft 16 connected to a second pair of wheels 18. In a number of variations, the wheels 14 may be front wheels, and the wheels 18 may be rear wheels. In a number of variations, the wheels 14, 18 may have tires 19 attached. In a number of variations, each drive shaft 12, 16 may have two separate portions connected via respective differential assemblies 22, 24, comprising axle differentials 15, 17 as may be readily understood by those skilled in the art. In a number of variations, each wheel 14, 16 may have a brake mechanism 20, shown as a disc brake. In a number of variations, the wheel 14, 16, tires 19, and brake mechanisms 20 may form a first and second wheel assembly 100. In a number of variations, the first driveshaft 12 may be connectable to a first transmission assembly 22, and the second driveshaft 16 may be connected to a second transmission assembly 24. In a number of variations, the first transmission assembly 22, an engine 26, an energy storage device 70, a controller 64, and the second transmission assembly 24 together, along with the first and second drive shafts 12, 16, and wheel assemblies 100, establish a powertrain 27 that provides various operating modes for forward and rearward propulsion of the vehicle 10. In a number of variations, the engine 26 may be an internal combustion engine, an external combustion engine, an electric motor, a hybrid engine, a fuel-cell or may be another type.

In a number of variations, the first transmission assembly 22 may be connected to the engine 26, which may have an output shaft 28 and an engine vibration dampener 30. In a number of variations, the transmission 22 assembly may include a first differential assembly 23 that may include an input shaft 32, a differential gear set that may be a planetary gear set 40, a first final drive 50 that may be a gear set, and the axle differential 15. In a number of variations, the first differential assembly 23 may include only some of these components. In a number of variations, the planetary gear set 40 may include a central sun gear member 42, a carrier member 46 that rotatably supports a plurality of planet gears 47, and a ring gear member 44. In a number of variations, the planet gears 47 may mesh with both the ring gear member 44 and the sun gear member 42. In a number of variations, the first final drive 50 may include a first gear 52 and a second gear 54 that may mesh with the first gear 52 and rotates commonly with a component of the axle differential 15, as is understood by those skilled in the art. In a number of variations, the final drive 50 may be a chain engaged with rotating sprockets or a combination of mechanical elements instead of meshing gears.

In a number of variations, the first transmission assembly 22 may include a first electric machine or drive motor 60. In a number of variations, the first drive motor 60 may be configured to be operable only as a generator, that is, may not be configured to be operated as a motor. In a number of variations, the first drive motor 60 may be operable as either a motor or as a generator, in different operating modes. In a number of variations, the first drive motor 60 may have cables 62 that electrically connect it to an electronic controller 64. In a number of variations, the first drive motor 60 may include a rotatable rotor and a stationary stator, arranged with an air gap between the stator and the rotor. However, for simplicity in the drawings, the first drive motor 60 is represented as a simple box. In a number of variations, the controller 64 may include an integrated rectifier to convert alternating current provided by the first drive motor 60 to direct current that can be stored in an energy storage device 70, such as a propulsion battery, connected through cables 62 to the controller 64. In a number of variations, those where the drive motor 60 may be operable as a motor, the controller 64 may also include an integrated power inverter for converting direct current from the energy storage device 70 to alternating current for operating the first drive motor 60. In a number of variations, the rectifier or the power inverter could be a separate component from the controller 64. In a number of variations, the power inverter may include an EMC filter.

In a number of variations, the first transmission assembly 22 may also include a first brake 66 that may be selectively engageable by the controller 64 to connect the ring gear member 44 to a stationary member 65, such as a transmission casing, to hold the ring gear member 44 stationary. In a number of variations, the transmission 22 may further include a rotating clutch 68 that may be selectively engageable by the controller 64 to couple the ring gear member 44 for common rotation with the first gear 52 of the first final drive 50. As used herein, “common rotation” means rotation at the same speed. In a number of variations, the clutch 68 may be concentric with the input shaft 32, but may not be connected for common rotation with the input shaft 32. That the clutch 68 may surround the input shaft 32 as a sleeve.

In a number of variations, the second transmission assembly 24 may include a second differential assembly 71 that may include a second final drive 72 that may be a gear set having a first gear 74 and a second gear 76 meshing with the first gear 74 and the axle differential 17, one portion of which rotates commonly with the second gear 76, as is understood by those skilled in the art. In a number of variations, the second differential assembly 71 may include only some of these components. In a number of variations, the final drive 72 may be a chain engaged with rotating sprockets or a planetary gear set or a combination of mechanical elements. In a number of variations, the second transmission assembly may also include a second electric machine or drive motor 80 which may be operable as a motor to propel the hybrid electric vehicle 10 or as a generator to assist in its propulsion or to provide or to assist in braking. In a number of variations, the second drive motor 80 may have cables 62 that electrically connect it to the controller 64. In a number of variations, the second drive motor 80 may include a rotatable rotor and a stationary stator, arranged with an air gap between the stator and the rotor, as is known. However, for simplicity in the drawings, the second drive motor 80 is represented as a simple box. In a number of variations, the controller 64 may also include an integrated power inverter to convert direct current from the energy storage device 70 to alternating current for operating the second drive motor 80 and to convert alternating current from the drive motor 80 to direct current that may be stored in an energy storage device 70. In a number of variations, the second driveshaft 16, like the first driveshaft 12, may be actually composed of two shafts, generally referred to as half-shafts, which may be connected to gears (not shown) within the respective axle differential 15, 17, as part of the first and second differential assemblies 23, 71.

In a number of variations, although a single controller 64 is illustrated and described as being operatively connected to both of the drive motors 60, 80, to the engine 26, to the first brake 66 and to the first clutch 68, multiple different controllers, all configured to communicate with one another, may be dedicated to one or more of these components. In a number of variations, the controller 64 may include an integrated power inverter to supply each drive motor 60, 80 with alternating current at a frequency corresponding to the operating speed of each drive motor, as is known. In a number of variations, controller 64 may be used to receive electrical power from the first drive motor 60 and to convey electrical power to the second drive motor 80.

In a number of variations, the planetary gear set 40 in the transmission assembly 22 may be used as a differential gear set. That is, each of the three coaxial rotating elements: the sun gear member 42, the carrier member 46, and the ring gear member 44, may be rotating simultaneously, so that the speed of the carrier member 46 may be the weighted average of the speeds of the sun gear member 42 and ring gear member 44, weighted by the numbers of teeth on the sun gear member 42 and the ring gear member 44. In a number of variations, the sun gear member 42 may be connected for common rotation with the first drive motor 60, the planet carrier member 46 may be connected for common rotation with the input shaft 32 and thus to the engine output shaft 28, and the ring gear member 44 may be connected to one side of the rotating first clutch 68 and may thereby be selectively connected to the final drive 50 when the first clutch 68 may be engaged.

In a number of variations, the engine 26 may be an internal combustion type with cylinders 90 as working chambers of the engine. In a number of variations, the engine 26 may have four cylinders 90 arranged along the crankshaft 28. As is known, valves may be used to admit air or an air-fuel mixture to each cylinder 90 and to exhaust combustion products from the cylinders 90 as part of exemplary engine operation in a four-stroke cycle of intake stroke, compression stroke, expansion stroke, and exhaust stroke. In a number of variations, the engine 26 may be equipped to selectively operate one or more cylinders 90, such as by selectively opening valves and admitting air or an air-fuel mixture to one or more cylinders 90 while air or combustion products remain trapped in the other cylinders 90 of the engine 26. The engine 26 may be either a spark-ignition engine or a compression-ignition (i.e. diesel) engine.

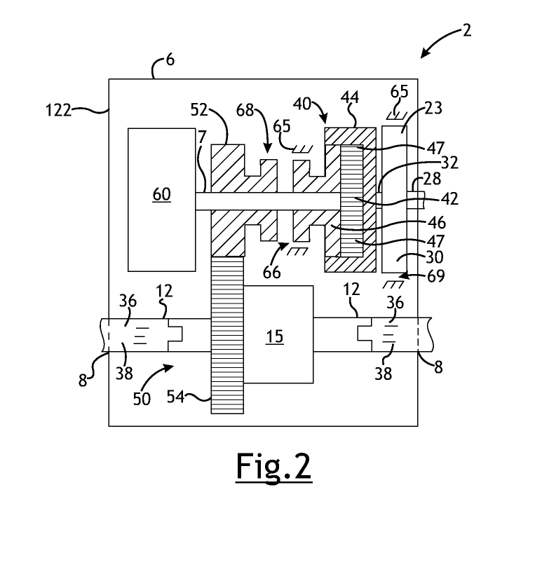

A number of variations are shown in FIG. 2. FIG. 2 shows an alternate arrangement of a third transmission assembly 122. In a number of variations, in the third transmission assembly 122, the sun gear member 42 of the planetary gear set 40 may be connected to the drive motor 60 as in FIG. 1, via a motor shaft 61, but the ring gear member 44 may be connected to the input shaft 32 and thus to the engine 26 through the engine output shaft 28. In a number of variations, the planet carrier member 46 may be connected to one side of the rotating clutch 68 and may thereby be selectively connected to the final drive 50 when the first clutch 68 may be engaged. In a number of variations, the planet carrier member 46 may also be grounded to the stationary member 65 by engagement of the brake 66. In a number of variations, an optional input brake 69 may be selectively engageable to ground the input member 32, and thus the engine 26, to the stationary member 65. In a number of variations, the optional input brake 69 enables an electric-only, all-wheel-drive operating mode in which the engine 26 may be off, and both drive motors 60 and 80 operate as motors. The optional provision of an input brake 69 and its use for an electric-only all-wheel-drive can also be made in an arrangement that is otherwise as shown in FIG. 1.

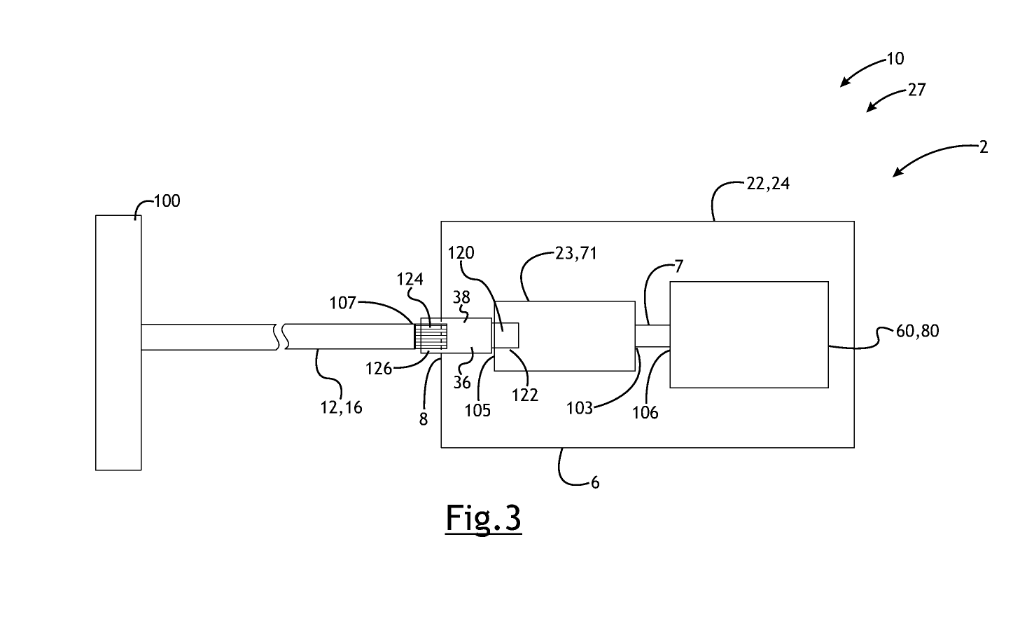

FIG. 3 depicts a portion of the powertrain 27 comprising a drivetrain 2 in schematic form, including either the first or second transmission assembly 22, 24, (including, but not limited to, transmission assembly components the first or second drive motor 60, 80, and first or second differential assembly 23, 71) the first or second driveshaft 12, 16, and the first or second wheel assemblies 100. In a number of variations, the transmission assembly 14 may include a housing 6. In a number of variations, the housing 16 may house several components of the transmission assembly 22, 24. In a number of variations, these components may include a drive motor 60, 80, a differential assembly 23, 71, and an output stub shaft 36. In a number of variations, the housing 6 may comprise a metal. In a number of variations, the housing 6 may comprise a ceramic. In a number of variations, the housing 6 may comprise a polymer. In a number of variations, the housing 6 may comprise a non-conducting material. In a number of variations, the housing 6 may comprise a polymeric material. In a number of variations, the housing 6 may comprise a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type.

In a number of variations, the housing 6 may insulate the driveshaft 12, 16, wheel assembly 100, drive train 2, powertrain 27, and/or vehicle 10 from electromagnetic interference (EMI) from the drive motor 60, 80 from electromagnetic interference (EMI) or “noise.” In a number of variations, the housing 6 may reduce emissions of EMI from the transmission assembly 22, 24 itself. EMI may affect the radio signals received in the vehicle 10 and its components including, but not limited to, infotainment systems and on-board receivers. In a number of variations, EMI may adversely affect electromagnetic compatibility (EMC) government regulation compliance for vehicles. In a number of variations, the housing 6 may contain an opening 8. In a number of variations, the opening 8 may allow for the driveshaft 12, 16 to connect with components of the transmission assembly 22, 24 to transfer power from the transmission assembly 22, 24 to the driveshaft 12, 16 which may then transfer power to the wheel assembly 100 to allow motion of the vehicle 10.

In a number of variations, the drive motor 60, 80 may contain a hybrid electric motor. In a number of variations, the drive motor 60, 80 may emit electromagnetic interference (EMI). In a number of variations, the differential assembly 23, 71 may convert the power provided by the drive motor 60, 80 to the driveshaft 12, 16. In a number of variations, a first shaft 7 may connect a first edge 106 of the drive motor 60, 80 to a first side 103 of the differential assembly 23, 71. In a number of variations, the differential assembly 23, 71 may increase or lessen the torque supplied by the drive motor 60, 80 to the driveshaft 12, 16. In a number of variations, the differential assembly 23, 71 may emit electromagnetic interference (EMI). In a number of variations, the output stub shaft 36 may connect a second side 105 of the differential assembly 23, 71 to a first end 107 of the driveshaft 12, 16. In a number of variations, the output stub shaft 36 may contain a spline 120 that connects to a grooved female section 122 at the first side 105 of the differential assembly 23, 71. In a number of variations, the driveshaft 12, 16 first end 107 may contain a spline 124 that connects to a grooved section 126 of the output stub shaft 36. In a number of variations, the output stub shaft 36 may span the opening 8 of the housing 6. In a number of variations, the output stub shaft 36 may insulate the driveshaft 12, 16, wheel assembly 100, drive train 2, powertrain 27, and or vehicle 10 from electromagnetic interference (EMI) from the drive motor 60, 80. In a number of variations, the output stub shaft 36 may reduce emissions of EMI from the transmission assembly 22, 24 itself.

In a number of variations, the output stub shaft 36 may comprise a ceramic. In a number of variations, the output stub shaft 36 may comprise a polymer. In a number of variations, the output stub shaft 36 may comprise a non-conducting material. In a number of variations, the output stub shaft 36 may comprise a polymeric material. In a number of variations, the output stub shaft 36 may comprise a material including, but not limited to, plastic steel, stainless steel, copper, nickel, tin, noble metals, zinc, iron, bronze, aluminum, titanium, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type.

In a number of variations, the drivetrain 2 may comprise a noise reduction component 38 may reduce emissions of EMI from the transmission assembly. In a number of variations, this reduction of EMI noise may increase radio reception of vehicle on-board receivers, and aid in meeting government EMC regulations. In a number of variations, the noise reduction component 38 may reduce the cost, mass, size and/or complexity of the EMC filter for the power inverter of the controller 64. In a number of variations, the noise reduction component 38 may be applied to the output stub shaft 36 as a coating. In a number of variations, the noise reduction component 38 may coat the entirety of the output stub shaft 36. In a number of variations, the noise reduction component 38 may coat the part of the output stub shaft 36 that goes through the opening 8 in the housing 6 of the transmission assembly 22, 24. In a number of variations, the noise reduction component 38 may be a piece located in the output stub shaft 36. In a number of variations, an EMI insulation barrier/coating may be applied to at least the splines 124 of a metal output stub shaft 36. In a number of variations, the noise reduction component 38 may be coated onto the output stub shaft 36 through a process of electrophoretic disposition. In a number of variations, electrophoretic disposition may include electrocoating, e-coating, cathodic electrodeposition, anodic electrodeposition, and electrophoretic coating, electrophoretic painting, or may be another type.

In a number of variations, the noise reduction component 38 may contain a metal including a sheet metal, a metal screen, metal ink, or a metal foam. In a number of variations, the noise reduction component 38 may be plastic. In a number of variations, the noise reduction component 38 may be made of a fibrous material. In a number of variations, the noise reduction component 38 may be made of an organic resin. In a number of variations, the noise reduction component 38 may be made of a ceramic material. In a number of variations, the noise reduction component 38 may comprise a non-conducting material. In a number of variations, the noise reduction component 38 may be made of a polymeric material. In a number of variations, the noise reduction component 38 may comprise a material including, but not limited to, plastic steel, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type.

In a number of variations, the noise reduction component 38 may be added to the driveshaft 12, 16. In a number of variations, the noise reduction component 38 may be added to the wheel assembly 100. In a number of variations, the noise reduction component 38 may be added to the housing 6. In a number of variations, the noise reduction component 38 may be added to the differential assembly 23, 71. In a number of variations, the noise reduction component 38 may be added to the drive motor 60, 80. In a number of variations, the noise reduction component 38 may contain a piece incorporated into the driveshaft 12, 16, wheel assembly 100, housing 6, differential assembly 23, 71, and/or drive motor 60, 80. In a number of variations, the noise reduction component 38 may be a part of the driveshaft 12, 16, wheel assembly 100, housing 6, differential assembly 23, 71, and/or drive motor 60, 80.

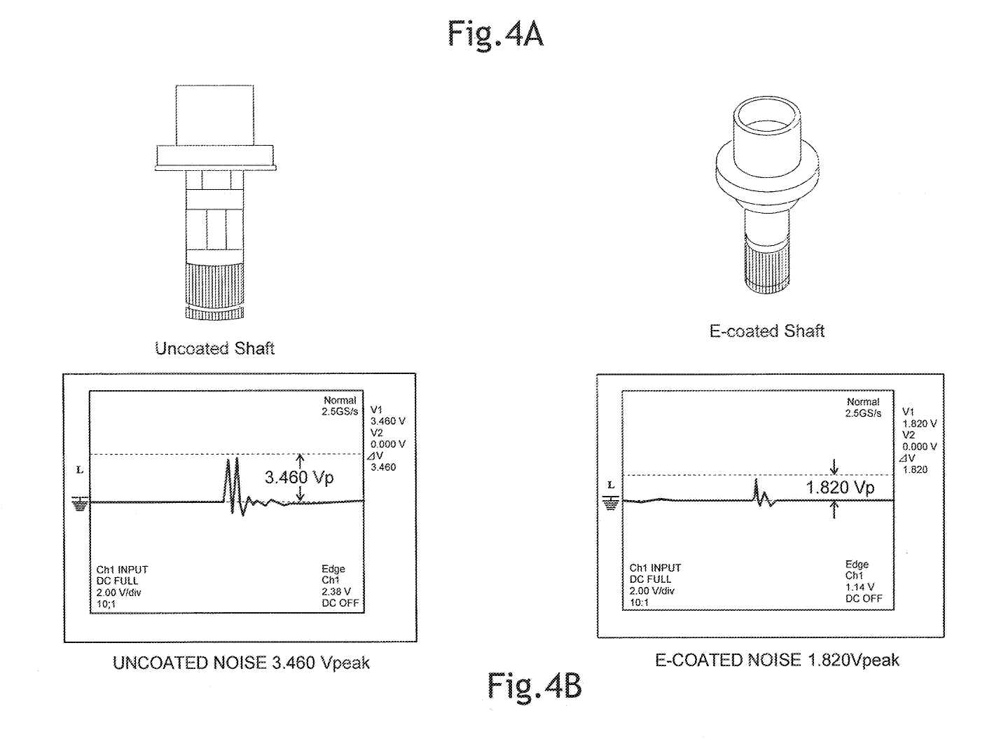

As shown in FIGS. 4 A-B, in a number of variations, the voltages of the driveshaft 12, 16 are shown with and without the noise reduction component 38 in or on the output stub shaft 36. In a number of variations the Vpeak of the noise may be reduced on an output stub shaft 36 e-coated with the noise reduction component 38 over an output stub shaft 36 with no noise reduction component 38.

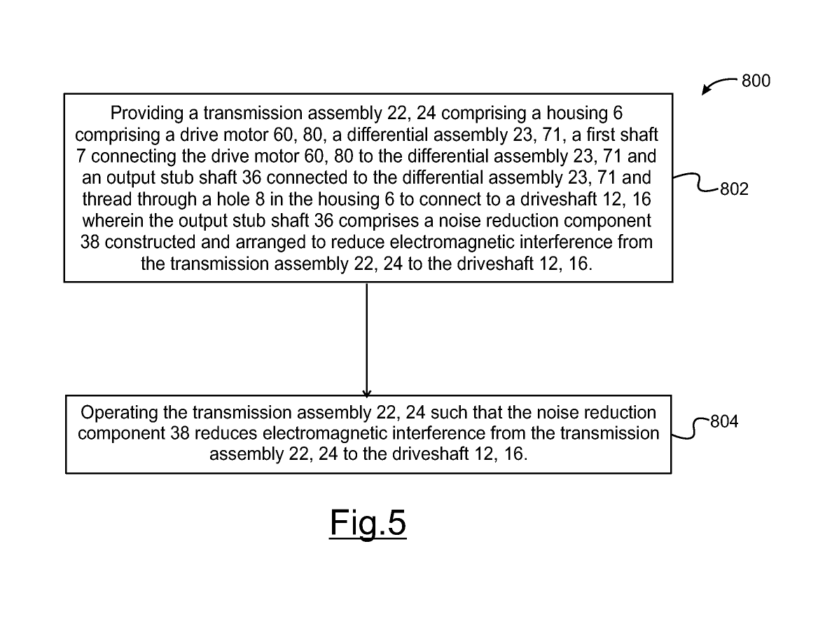

As shown in FIG. 5, in a number of variations, a method 800 may be shown wherein the method in block 802 includes providing a transmission assembly 22, 24 comprising a housing 6 comprising a drive motor 60, 80, a differential assembly 23, 71, a first shaft 7 connecting the drive motor 60, 80 to the differential assembly 23, 71, and an output stub shaft 36 connected to the differential assembly 23, 71 and thread through a hole 8 in the housing 6 to connect to a driveshaft 12, 16 wherein the output stub shaft 36 comprises a noise reduction component 38 constructed and arranged to reduce electromagnetic interference from the transmission assembly 22, 24 to the driveshaft 12, 16. In a number of variations, the method 800 in block 804 further includes operating the transmission assembly 22, 24 such that the noise reduction component 38 reduces electromagnetic interference from the transmission assembly 22, 24 to the driveshaft 12, 16.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft.

Variation 2 may include a product as set forth in Variations 1 wherein the product comprises an electric vehicle.

Variation 3 may include a product as set forth in any of Variations 1-2 wherein the drivetrain is connected to a wheel assembly.

Variation 4 may include a product as set forth in any of Variations 1-3 wherein the noise reduction component is introduced to the output stub shaft through electrophoretic disposition.

Variation 5 may include a product as set forth in any of Variations 1-4 wherein the noise reduction component comprises an organic resin.

Variation 6 may include a product as set forth in any of Variations 1-5 wherein the noise reduction component comprises a non-conducting material.

Variation 7 may include a product as set forth in any of Variations 1-6 wherein the noise reduction component is applied as a coating on the spline of the output stub shaft.

Variation 8 may include a product as set forth in Variations 1-7 wherein a noise reduction component is applied to the first shaft.

Variation 9 may include a product as set forth in any of Variations 1-8 wherein a noise reduction component is applied to the housing.

Variation 10 may include a product as set forth in any of Variations 1-9 wherein a noise reduction component is applied to the driveshaft.

Variation 11 may include a method including providing a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft; and operating the transmission assembly such that the noise reduction component reduces electromagnetic interference from the transmission assembly to the driveshaft.

Variation 12 may include a method as set forth in Variation 11 wherein the product comprises an electric vehicle.

Variation 13 may include a method as set forth in and of Variations 11-12 wherein the drivetrain is connected to a wheel assembly.

Variation 14 may include a method as set forth in any of Variations 11-13 wherein the noise reduction component is introduced to the output stub shaft through electrophoretic disposition.

Variation 15 may include a method as set forth in any of Variations 11-14 wherein the noise reduction component comprises an organic resin.

Variation 16 may include a method as set forth in any of Variations 11-15 wherein the noise reduction component comprises a non-conducting material.

Variation 17 may include a method as set forth in any of Variations 11-16 wherein the noise reduction component is applied as a coating on the spline of the output stub shaft.

Variation 18 may include a method as set forth in any of Variations 11-17 wherein a noise reduction component is applied to the first shaft.

Variation 19 may include a method as set forth in any of Variations 12-18 wherein a noise reduction component is applied to the housing.

Variation 20 may include a method as set forth in any of Variations 11-19 wherein a noise reduction component is applied to the driveshaft.

Variation 21 may include a method, and/or a product as set forth in any of Variations 1-20 wherein the vehicle is a an a hybrid electric vehicle (HEV) that is gasoline and electric powered, a plug-in hybrid electric vehicle (PHEV), a battery electric vehicle (BEV), or a plug-in electric vehicle (PEV).

Variation 22 may include a method, and/or a product as set forth in any of Variations 1-21 wherein the engine is an internal combustion engine, an external combustion engine, an electric motor, or a hybrid engine.

Variation 23 may include a method, and/or a product as set forth in any of Variations 1-22 wherein the driveshaft connects to a wheel assembly comprising wheels, tires, and a brake mechanism.

Variation 24 may include a method, and/or a product as set forth in any of Variations 1-23 wherein the drive motor operates as a generator.

Variation 25 may include a method, and/or a product as set forth in any of Variations 1-24 wherein the drive motor connects to a electrical controller comprising a integrated rectifier to convert alternating current to direct current to be stored in an energy storage device, and/or a power inverter for converting direct energy from the energy storage device to alternating current to operate the drive motor.

Variation 26 may include a method, and/or a product as set forth in any of Variations 25 wherein power inverter comprises an EMC filter.

Variation 26 may include a method, and/or a product as set forth in any of Variations 24-25 wherein the controller directs electrical power to or from the drive motor and a second drive motor.

Variation 27 may include a method, and/or a product as set forth in any of Variations 1-26 wherein the transmission assembly is equipped to operate the wheel assembly in all wheel drive.

Variation 28 may include a method, and/or a product as set forth in any of Variations 1-27 wherein the housing comprises a material comprising at least one of plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, or combinations thereof.

Variation 29 may include a method, and/or a product as set forth in any of Variations 1-28 wherein the differential assembly increases or lessens the torque supplied by the drive motor to the driveshaft.

Variation 30 may include a method, and/or a product as set forth in any of Variations 1-29 wherein the drive motor contains a hybrid electric motor.

Variation 31 may include a method, and/or a product as set forth in any of Variations 1-30 wherein the output stub shaft contains a spline.

Variation 32 may include a method, and/or a product as set forth in any of Variations 1-31 wherein the output stub shaft comprises a material including at least one of plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, or combinations thereof.

Variation 33 may include a method, and/or a product as set forth in any of Variations 1-32 wherein noise reduction component coats only the part of the output stub shaft that aligns with the opening of the transmission assembly.

Variation 34 may include a method, and/or a product as set forth in any of Variations 1-33 wherein the noise reduction component coats the entirety of the output stub shaft.

Variation 35 may include a method, and/or a product as set forth in any of Variations 1-34 wherein the noise reduction component comprises a material including at least one of shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, or combinations thereof.

The above description of select examples of the invention is merely exemplary in nature and, thus, variations or variants thereof are not to be regarded as a departure from the spirit and scope of the invention.

1. A product comprising: a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft.

2. A product as set forth in claim 1 wherein the product comprises an electric vehicle.

3. A product as set forth in claim 1 wherein the drivetrain is connected to a wheel assembly.

4. A product as set forth in claim 1 wherein the noise reduction component is introduced to the output stub shaft through electrophoretic disposition.

5. A product as set forth in claim 1 wherein the noise reduction component comprises an organic resin.

6. A product as set forth in claim 1 wherein the noise reduction component comprises a non-conducting material.

7. A product as set forth in claim 1 wherein the noise reduction component is app lied as a coating on the spline of the output stub shaft.

8. A product as set forth in claim 1 wherein a noise reduction component is app lied to the first shaft.

9. A product as set forth in claim 1 wherein a noise reduction component is app lied to the housing.

10. A product as set forth in claim 1 wherein a noise reduction component is app lied to the driveshaft.

11. A method comprising: providing a transmission assembly comprising a housing and a plurality of components within the housing comprising a drive motor that emits electromagnetic interference, a differential assembly, a first shaft connecting the drive motor to the differential assembly, and an output stub shaft connected to the differential assembly and thread through a hole in the housing to connect to a driveshaft wherein the output stub shaft comprises a noise reduction component constructed and arranged to reduce electromagnetic interference from the transmission assembly to the driveshaft; and
operating the transmission assembly such that the noise reduction component reduces electromagnetic interference from the transmission assembly to the driveshaft.

12. A method as set forth in claim 11 wherein the product comprises an electric vehicle.

13. A method as set forth in claim 11 wherein the drivetrain is connected to a wheel assembly.

14. A method as set forth in claim 11 wherein the noise reduction component is introduced to the output stub shaft through electrophoretic disposition.

15. A method as set forth in claim 11 wherein the noise reduction component comprises an organic resin.

16. A method as set forth in claim 11 wherein the noise reduction component comprises a non-conducting material.

17. A method as set forth in claim 11 wherein the noise reduction component is applied as a coating on the spline of the output stub shaft.

18. A method as set forth in claim 11 wherein a noise reduction component is applied to the first shaft.

19. A method as set forth in claim 11 wherein a noise reduction component is applied to the housing.

20. A method as set forth in claim 11 wherein a noise reduction component is applied to the driveshaft.
